(19) United States
(12) Patent Application Publication
(10) Pub. No.: US 2003/0202117 A1
(43) Pub. Date: Oct. 30, 2003

(54) Security monitor screens & cameras

(76) Inventor: Steven Alonzo Garner, Flint, MI (US)

Correspondence Address: Steven Garner, 609 E Lyndon, Flint, MI, 48505, US

(21) Appl. No.: 10/367,930

(22) Filed: Feb. 19, 2003

Related U.S. Application Data
(60) Provisional application No. 60/374,300, filed on Apr. 22, 2002.

(51) Int. Cl. H04N 5/225

(52) U.S. Cl. 348/373

(57) ABSTRACT

What make my idea invention new and different is having the ability to view an entire home or business facility before setting a foot inside when a burglar alarm system is trigger on the premises. The main purpose of my idea invention is to co-work with alarm systems in a burglary situation. The problem with alarm systems, they only alert owners by hearing. But my invention give owner's eyes into their facility from the outside an inside to determine if it's safe to enter or roam around in. This idea invention not only let you see but see thoroughly with night visual and heat sensing screen. The night visual, heat sensing screen give owner of this invention a extra edge by seeing in the dark when all lights in the facility are off and seeing heat waves images of a intruder on the monitor screen.

This invention also allows home and business owners to carry a hand held design interior monitor screen inside a facility. This will put an end to old style television station monitors for homes and some businesses. This invention will also be helpful to fire fighters in fire situations. These monitors can let firefighters view areas in a home or business facility to search for trap people in fires and non-firetrap areas.

The Two Monitor Panel Frames are made of plastic and fiberglass material. The two monitor panel frames are measure at 10 inches in width and 6 inches in length. The monitor panel frames are measure at 1 inch and a half in vertical width when lying flat. The two-monitor panel frames house a 6 inches in width and 5 inches in length Flat Plastic Display Screen. The two monitor panel frames also house a soft touch button pad bar. The button pad bar is measure at 2 inches and a half-inch in width and 5 inches in length. The flat plastic display screen and button pad bar are center measure at a half inch from the top and bottom of the monitor panel frames.

The flat plastic screen display begin a half inch from the left side of the monitor panel frames and end 6 inches across the monitor panel frames. The flat plastic screen displays shows a clear color view of and area shown by the cameras one view at a time. The flat plastic screen displays is also equipped with a night visual screen and heat-sensing screen. The night visual screen is design to let owners see areas in the dark when all lights are off in a camera view. The heat-sensing screen is design to detect any living being that give off body heat in an area of a camera view. The Soft Touch Button Pad Bar begins a half-inch from the display screen. The button pad bar measure at 2 inches an a half in width an 5 inches in length that end a half inch from the right side of monitor panel frames. The monitor panel frames also house a Radar Transmitter Sensor Box that send and receive signals and pictures shown by each camera views.

The soft button pad bar is consisting of eight buttons that are on the two monitor panels. The Regular Color Screen button shows a clear color view of all camera views. The Night Visual Screen button shows a clear view of an area in the dark for all camera views. The Heat Visual Screen button shows heat given off any living being that is in that camera view for all cameras. The next two sets of buttons of the button pad bar are the Back Arrow button and Forward Arrow button. The Forward Arrow button is to move forward to view the next available screen view. The Back Arrow button is to move back to the last available screen view. The button pad bar also has three other buttons that is included. The Keyboard Screen button is a button to show a computerize alphabetical letters screen to label each camera view the owner choose. The Enter button is to input data information in the monitor panel memory data box. The Security Screen button is to input a five digital letter code to conceal both monitor panel screen view.

There are three different color Camera Frames black, white, and clear transparent. There is only one camera frame design to fit in corners, flat base surfaces and oval corner areas. The camera frames are made of plastic and fiberglass material. The camera frames also house a Radar Transmitter Sensor Box that send signals and pictures to and from the cameras and monitor panels.

The Camera Frame Base Brackets are consisted of three different designs corner angle, oval angle, and flat base. The corner camera base bracket is design to fit in a 90-degree corner angle. The flat base camera base bracket is design for flat smooth surface areas. The oval camera base bracket is design for oval surfaces or corner areas. The Camera Frame is measure 2 inch in length and 1 inch in width extendable cylinder tube that can extend 4 inches in length. The cylinder tube has a pivot ball joint that rotate at a 360-degree angle at the end of cylinder. Connected to the pivot ball joint is a 1-inch and a half in width and 1 inch and a half in length cylinder tube camera lens head. The camera lens head is equipped with wide view angle lens. The pivot ball joint give the camera lens head a 360-degree any angle direction turn.

The Exterior and Interior Monitor Panel Frames also house two Adaptor Recorder Plugs on the left front side of the panel frame. Any VHS, DVD, camcorder or video recorder systems can be wire connected to the monitor panel adaptor plugs to record from the camera view the monitor panel screen is set to show. This gives the owners of the Exterior and Interior Monitors System the option to record of any camera view the owner choose.

### BACKGROUND, DESCRIPTION AND SUMMARY OF EXTERIOR AND INTERIOR SECURITY MONITOR SCREENS AND CAMERAS

The Exterior and Interior Security Monitor Screens and Cameras are in the field of business and home security systems technology. It will be the most effective and latest high electronic tech no logy invention in its field of security systems to work hand in hand with all burglar alarm systems. There are many high tech alarm systems that alert homeowners and business owners of break-ins but the problem with most security systems are their incomplete alert systems. Most alarm systems alert home and business owners by hearing. Those alarm systems are effective but can cause the homeowners and business owners to become confuse and panic in a burglary situation when their alarm is trigger. Those alarm systems also leave owners of a facility not aware where the intruder is at in their facility. The Exterior and Interior Security Monitor Screen give homeowners and business owner a fix eye view of what is going on around in their facility, no matter where they are in their facility or outside of it.

In today's news more people are being assaulted, raped, and killed when entering into their own homes and businesses. Most people don't know what wait for them while entering their homes or businesses especially when their burglar alarm is alerted. My idea invention is design to solve homeowners and business owner's fears of not knowing if the intruders are still in their facility or not and preventing being ambush or walking into a facility while a burglary is in process. The Exterior an Interior Security Monitors also keep homeowners or business owner two step ahead of an intruder whether from the inside or outside. For example when a homeowner is aware of a suspicious noise or when their burglar alarm is alerted the hand held design interior monitor can be use by the homeowner or business owner to search the entire interior of a house or business facility. This will lease the danger for homeowners and business owner's lives of being in jeopardy of walking into danger in their home or business while investigating strange noises and wondering why their burglar alarm is alerted. This idea invention will save lives, keep home owners two steps ahead of intruders, give them enough time to think to prevent getting harm and walking into danger when their alarm systems is alerted.

The two monitor panels can be install any where in or on a facility but for better use for this design invention is for one of the monitor panel to be install outside of and on a facility by the main entrance or exit of a house or business building. The second monitor panel can be installed any place inside or outside of a facility. A homeowner might want to install the second monitor inside the facility in the main lounging room. The monitor panel probably should be install by an emergency phone or bedside, the interior monitor panel also can be mobile to move around and about with the monitor panel. This example might be preferred by business owners who are posted or constantly mobile in their facility.

The camera base brackets and camera frames are design to be installing concealable and invisible. The camera small frame along with the colors is design to be install in areas that is out of the eye range. The camera base brackets are design to mount on flat base surface, corner angle and oval angle areas. The camera body frame is an extended tube frame and a 360-degree pivot lens head. This camera design give homeowners and business owner more than one camera angle view. These cameras can be installing any where in a facility to fit the view of the consumer.

The Exterior and Interior Security Monitors Screens would be a new electronic technology idea invention. There is no security surveillance system able to let homeowners and business owners view a facility while outside of it or anywhere while in it when there burglar alarm system is trigger. The interior monitor screen give home owners a view of their facility in a hand held design monitor screen while being mobile in it or outside of it. This idea invention not only allows owners to view an area of a facility but record any area they choose. The monitor screens also can work hand in hand with other alarm systems for example: a protection housedog, motion detectors and trigger wires system. The monitor screens can also be useful devise to law enforcement doing hostage situations. The monitor screens can be use to locate the hostages and the criminals in the facility. It will also save law enforcement time of going to people homes and business to investigate thousands of false alarm calls. My idea invention will not only serve homeowners and business owners, but city protection public service workers will benefit from it too. These monitors will change are ways of living for the best.

1. I Steven Garner claim to be the idea inventor of the Exterior and Interior Security Monitor Screens, Camera Base Brackets and Camera design.

2. I Steven Garner claim to be only idea inventor of the Exterior and Interior Security Monitor Screens, Camera Base Brackets, and Camera design.

3. I Steven Garner claim to be the designer of the Exterior and Interior Security Monitor Screens, Camera Base Brackets and Camera design.

4. I Steven Garner claim to be the document recorder of Exterior and Interior Security Monitor Screens and Camera documents.

5. I Steven Garner claim all rights and responsibility of the Exterior and Interior Monitor Screens and Camera invention.

6. I Steven Garner claim to be the applicant on the patent application Ser. No. 60/374,300.

7. I Steven Garner claim the fees for my patent application forms.

8. I Steven Garner claim that I filed my patent application on Apr. 22, 2002.

9. I Steven Garner claim to be register applicant of Document Disclosure Statement Office.

10. I Steven Garner claim to be a legal United States citizen.

11. I Steven Garner claim to be a resident at 609 E Lyndon Flint, Mich. 48505.
